(19) United States
(12) Patent Application Publication
(10) Pub. No.: US 2015/0136033 A1
(43) Pub. Date: May 21, 2015

(54) WATER DRINKING DEVICE FOR PETS

(71) Applicant: John Hoskins, Costa Mesa, CA (US)

(72) Inventor: John Hoskins, Costa Mesa, CA (US)

(21) Appl. No.: 14/081,254

(22) Filed: Nov. 15, 2013

(51) Int. Cl. A01K 7/00; F16M 13/02; A01K 29/00

(52) U.S. Cl. CPC A01K 7/00; A01K 29/00; F16M 13/02
USPC 119/72

(57) ABSTRACT

A water drinking device for pets, includes a cup including a bottom, and a wall extending upwardly from the bottom and defining an inner hollow constructed so that a bottle with water can be received in the inner hollow and held in it and thereafter removed from the inner hollow of the wall for pouring water from the bottle into the inner hollow to allow a pet to drink water from it, and the wall is transversely stretchable and contractible such that when a bottle with a transverse dimension that is greater than a transverse dimension of the inner hollow is inserted into the latter, the wall stretches transversely outwardly, and upon removal of the bottle from the inner hollow the wall contracts back to its initial transverse size, and the wall is also constructed so that the cup is insertable into a cup holder of a vehicle.

### BACKGROUND OF THE INVENTION

The present invention relates to water drinking devices for pets. More particularly it relates to such water drinking devices for pets, which are associated with water bottles.

Devices of the above- mentioned general types are known in the art. For example, U.S. Pat. No. 6,405,675 discloses a water drinking device with a cup connectable to a water bottle. U.S. Pat. No. 7,490,577 discloses a water drinking device provided with a pan with a clip, connected to a water bottle. U.S. Pat. No. 7,287,487 discloses a water drinking device having a cup which is connectable with and disconnectable from a water bottle via interengaging projections and grooves.

It is believed that the water drinking devices for pets can be improved in a direction of simplification of their manufacture and use.

### SUMMARY OF THE INVENTION

Accordingly it is an object of the present invention to provide a water drinking device for pets, which is a further improvement of the existing devices.

In keeping with these objects and with others which will become apparent hereinafter, one feature of the present invention resides, briefly stated, in a water drinking device for pets, comprising a cup including a bottom, and a wall extending upwardly from said bottom and defining an inner hollow constructed so that a bottle with water can be received in said inner hollow and held in it and thereafter removed from said inner hollow of said wall for pouring water from said bottle into said inner hollow to allow a pet to drink water from it, wherein said wall is transversely stretchable and contractible such that when a bottle with a transverse dimension that is greater than a transverse dimension of said inner hollow is inserted into the latter, said wall stretches transversely outwardy, and upon removal of the bottle from said inner hollow said wall contracts back to its initial transverse size, wherein said wall is also constructed so that said cup is insertable into a cup holder of a vehicle.

In accordance with another feature of the present invention, said wall has smooth inner walls which bound said inner hollow so as to hold the bottle inside it inclusively due to stretching and contracting properties of said wall.

In accordance with further feature of the present invention said wall is transversely compressible such that when said cup is inserted into the cup holder of a vehicle having a smaller transverse dimension that said wall, said wall compresses and allows said cup to be introduced into the cup holder.

In accordance with a further feature of the present invention said bottom is thicker than said wall such that when said cup is placed on a supporting surface it stably stands on the supporting surface.

In accordance with a further feature of the present invention said inner cavity of said wall has a shape selected from the group consisting of a cylindrical shape, upwardly expanding shape, with a circular cross section, and with a non-circular cross section.

In accordance with a further feature of the present invention said wall is composed of a material selected from the group consisting of a stretchable and contractible rubber, a stretchable and contractive polymeric material, and a stretchable and contractible foam material.

In accordance with a further feature of the present invention said device also includes the bottle insertable into and removable from said inner hollow of said wall.

In accordance with a further feature of the present invention said device also includes the cup holder of a vehicle, in which said cup is insertable.

In accordance with a further feature of the present invention said cup is constructed as a one-piece element.

The novel features of the invention are set forth in particular in the appended claims. The invention itself will be best understood from the following description of the preferred embodiments, which is accompanied by the following drawings.

### BRIEF DESCRIPTION OF THE DRAWINGS

FIG. 1 is a view showing a cross section of a cup of a water drinking device for pets in accordance with the present invention; and

FIG. 2 is a view showing a cup in accordance with a further embodiment of the invention, with a water bottle and a vehicle cup holder.

### DESCRIPTION OF THE PREFERRED EMBODIMENTS

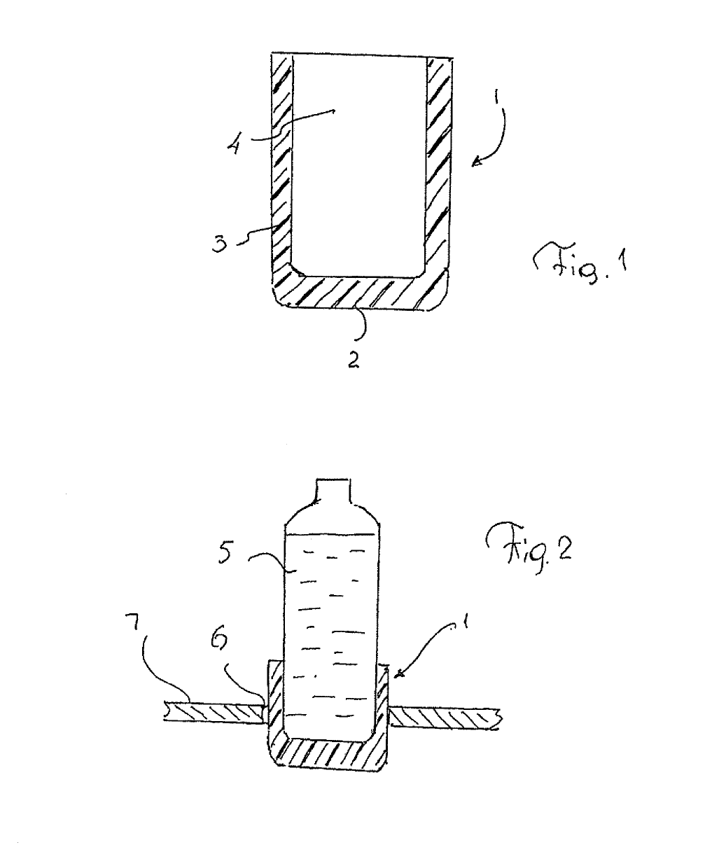

A water drinking device for pets in accordance with a present invention has a cup which is identified as a whole in FIG. 1 with reference numeral 1. The cup is has a bottom 2 and a wall 3 extending upwardly from the bottom 2 and defining an inner hollow 4 to be filled with water.

A water bottle 5 can be received in the inner hollow 4 of the wall 3 and held there, for example during traveling. When it is necessary to give water to a pet, the bottle 5 is removed from the inner hollow 4 of the wall 3 of the cup 1, water from the bottle 5 is poured into the inner hollow 4, and the cup 1 is placed with his bottom 2 onto a supporting surface, for example on the ground. A pet can drink from the cup 1.

The bottom 2 of the cup 1 is thicker than the wall 3 so as to provide a stable standing of the cup 1 on the supporting surface, in particular during drinking of water from the inner hollow 4 of the cup 1.

The wall 3 of the cup 1 is stretchable and contractible, so that when for example the bottle 5 that has a transverse dimension that is greater than the transverse dimension of the inner hollow 4 is inserted into the inner hollow 4, the wall 3 stretches transversely and holds the bottle 5 reliably, since the wall 3 tries to contract back to its original transverse dimension. When the bottle 5 is removed from the inner hollow 4, the wall 3 is restored to its original shape.

It is to be understood that the bottle can be introduced into the inner hollow 4 of the cup 1 so as to reach its bottom, or can be introduced so that the bottom of the bottle is spaced from the bottom of the cup 1.

For this purpose, the wall 3 is composed of a stretchable and contractible material, such as rubber, polymeric material, foam material. The wall 3 has a smooth inner surface which bounds the inner hollow 4, so that the holding of the bottle inside the inner hollow is carried out exclusively due to the stretching and contracting properties of the wall 3.

The inner hollow 4 of the wall 3 can be cylindrical as shown in FIG. 1 or can be of an upwardly expanding shape as shown in FIG. 2. It can also have a circular cross-section or a non-circular cross-section.

The cup as a whole, including the bottom 2 and the wall 3, can be formed as a one-piece element, composed of one-piece material.

The cup 1 with the bottle 5 inside it is introducible into an opening 6 of a cup holder 7 of a vehicle.

In a preferable embodiment, the wall 3 of the cup 1 is compressible, so that when the cup 3 with the bottle 5 inside it is introduced into the opening 6 with a transverse dimension that is smaller than the transverse outside dimension of the wall 3, the wall 3 compresses, to allow such introduction and to provide a reliable hold of the cup 1 with the bottle 5 in the cup holder of the vehicle.

The invention is not limited to the details shown since further modifications and structural changes are possible without departing from the spirit of the invention.

What is desired to be protected by Letters Patent is set forth in the appended claims.

1. A water drinking device for pets, comprising:
a cup including a bottom, and a wall extending upwardly from said bottom and defining an inner hollow constructed so that a bottle with water can be received in said inner hollow and held in it and thereafter removed from said inner hollow of said wall for pouring water from said bottle into said inner hollow to allow a pet to drink water from it, wherein said wall is transversely stretchable and contractible such that when a bottle with a transverse dimension that is greater than a transverse dimension of said inner hollow is inserted into the latter, said wall stretches transversely outwardly, and upon removal of the bottle from said inner hollow said wall contracts back to its initial transverse size, wherein said wall is also constructed so that said cup is insertable into a cup holder of a vehicle.

2. A water drinking device for pets as defined in claim 1, wherein said wall has smooth inner walls which bound said inner hollow so as to hold the bottle inside it inclusively due to stretching and contracting properties of said wall.

3. A water drinking device as defined in claim 1, wherein said wall is transversely compressible such that when said cup is inserted into the cup holder of a vehicle having a smaller transverse dimension that said wall, said wall compresses and allows cup to be introduced into the cup holder.

4. A water drinking device as defined in claim 1, wherein said bottom is thicker than said wall such that when said cup is placed on a supporting surface it stably stands on the supporting surface.

5. A water drinking device as defined in claim 1, wherein said inner cavity of said wall has a shape selected from the group consisting of a cylindrical shape, upwardly expanding shape, with a circular cross section, and with a non-circular cross section.

6. A water drinking device as defined in claim 1, wherein said wall is composed of a material selected from the group consisting of a stretchable and contractible rubber, a stretchable and contractive polymeric material, and a stretchable and contractible foam material.

7. A water drinking device as defined in claim 1, wherein said device also includes the bottle insertable into and removable from said inner hollow of said wall.

8. A water drinking device as defined in claim 7, wherein said device also includes the cup holder of a vehicle, in which said cup is insertable.

9. A water drinking device as defined in claim 1, wherein said cup is constructed as a one-piece element.
